(19) United States
(12) Patent Application Publication
(10) Pub. No.: US 2015/0120443 A1
(43) Pub. Date: Apr. 30, 2015

(54) IDENTIFYING OBJECTS IN PHOTOGRAPHS

(71) Applicant: International Business Machines Corporation, Armonk, NY (US)

(72) Inventors: Yuk L. Chan, Poughkeepsie, NY (US); Christopher Cramer, Troy, NY (US); Robert G. King, Longmont, CO (US); Deepti M. Naphade, Fishkill, NY (US); Jairo A. Pava, Wappingers Falls, NY (US)

(73) Assignee: International Business Machines Corporation, Armonk, NY (US)

(21) Appl. No.: 14/067,103

(22) Filed: Oct. 30, 2013

(51) Int. Cl. G06Q 30/02; G06Q 50/00

(52) U.S. Cl. CPC G06Q 30/0255; G06Q 50/01
USPC 705/14.53

(57) ABSTRACT

In an exemplary embodiment, a computer-implemented method includes receiving a photo showing a taggable object, wherein the taggable object is a purchasable object that has not yet been identified. First purchase data is collected related to past purchases of a first user associated with the photo. The first purchase data is compared to the taggable object to determine whether one or more purchased items potentially match the taggable object. A set of potential matches is generated, by a computer processor, based at least in part on comparing the first purchase data to the taggable object. The taggable object is tagged in the photo with an identifier representing at least one of the potential matches.

### BACKGROUND

Various embodiments of this disclosure relate to image analysis and, more particularly, to recognizing objects in digital photographs.

Social networking sites, such as Facebook®, allow users to identify people in photographs. Such an identification results in a tag, which indicates that a specific person appears in a specific photo. For instance, after a photo is uploaded to Facebook, the user who uploaded the photo may associate a section of the photo with a person's Facebook profile, thus “tagging” that person in the photo. The photo then appears on the tagged person's profile, indicating that the photo contains an image of that tagged person. In some cases, a social networking site can make suggestions as to which people might appear in a photo, based on image analysis and previous identifications.

### SUMMARY

In one embodiment of this disclosure, a computer-implemented method includes receiving a photo showing a taggable object, wherein the taggable object is a purchasable object that has not yet been identified. First purchase data is collected related to past purchases of a first user associated with the photo. The first purchase data is compared to the taggable object to determine whether one or more purchased items potentially match the taggable object. A set of potential matches is generated, by a computer processor, based at least in part on comparing the first purchase data to the taggable object. The taggable object is tagged in the photo with an identifier representing at least one of the potential matches.

In another embodiment, a system includes a selection unit, a purchase unit, and a tagging unit. The selection unit is configured to select a taggable object appearing in a photo. The purchase unit is configured to collect first purchase data related to past purchases of a first user associated with the photo, and to compare the first purchase data to the taggable object to determine whether one or more purchased items potentially match the taggable object. The tagging unit is configured to generate a set of potential matches based, at least in part, on comparing the first purchase data to the taggable object, and to tag the taggable object in the photo with an identifier representing at least one of the potential matches.

In yet another embodiment, a computer program product includes a computer readable storage medium having computer readable program code embodied thereon. The computer readable program code is executable by a processor to perform a method. The method includes receiving a photo showing a taggable object, wherein the taggable object is a purchasable object that has not yet been identified. Further according to the method, first purchase data is collected related to past purchases of a first user associated with the photo. The first purchase data is compared to the taggable object to determine whether one or more purchased items potentially match the taggable object. A set of potential matches is generated, by a computer processor, based at least in part on comparing the first purchase data to the taggable object. The taggable object is tagged in the photo with an identifier representing at least one of the potential matches.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a computing device in which a tagging system may be embodied, in whole or in part, according to an exemplary embodiment of this disclosure;

FIG. 2 is a block diagram of the tagging system, according to an exemplary embodiment of this disclosure; and

FIG. 3 is a flow diagram of a method for tagging an object in a photo, according to an exemplary embodiment of this disclosure.

### DETAILED DESCRIPTION

Various embodiments of this disclosure enable tagging of objects in digital media, such as photographs. Object-tagging may enable users to endorse items appearing in their photos, such as branded shoes or clothing. An exemplary tagging system may suggest tags for objects based, at least in part, on data previously stored related to users associated with a photo. The tagging system may make one or more suggestions for tagging specific objects in the photo, and the user may have a choice as to which tags to use or whether to apply tags at all.

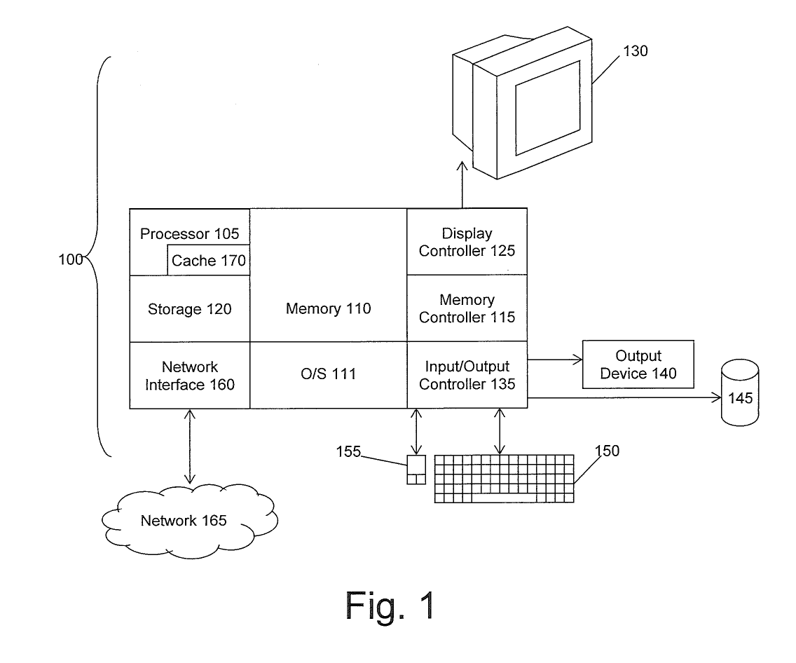

FIG. 1 illustrates a block diagram of a computer system 100 for use in implementing a tagging system or method according to some embodiments. The tagging systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 100, such as a personal computer, workstation, minicomputer, or mainframe computer.

In an exemplary embodiment, as shown in FIG. 1, the computer system 100 includes a processor 105, memory 110 coupled to a memory controller 115, and one or more input and/or output (I/O) devices 140 and 145, such as peripherals, that are communicatively coupled via a local I/O controller 135. The I/O controller 135 may be, for example but not limitation, one or more buses or other wired or wireless connections, as are known in the art. The I/O controller 135 may have additional elements, which are omitted for simplicity, such as controllers, buffers (caches), drivers, repeaters, and receivers, to enable communications.

The processor 105 is a hardware device for executing hardware instructions or software, particularly those stored in memory 110. The processor 105 may be any custom made or commercially available processor, a central processing unit (CPU), an auxiliary processor among several processors associated with the computer system 100, a semiconductor based microprocessor (in the form of a microchip or chip set), a macroprocessor, or other device for executing instructions. The processor 105 includes a cache 170, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 170 may be organized as a hierarchy of more cache levels (L1, L2, etc.).

The memory 110 may include any one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, or other types of storage media. Note that the memory 110 may have a distributed architecture, where various components are situated remote from one another but may be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially may control the execution of other computer programs and provides scheduling, input-output control, file and data management, memory management, and communication control and related services.

Additional data, including, for example, instructions for the processor 105 or other retrievable information, may be stored in storage 120, which may be a storage device such as a hard disk drive.

In an exemplary embodiment, a conventional keyboard 150 and mouse 155 may be coupled to the I/O controller 135. Other output devices such as the I/O devices 140 and 145 may include input devices, for example but not limited to, a printer, a scanner, a microphone, and the like. The I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like.

The computer system 100 may further include a display controller 125 coupled to a display 130. In an exemplary embodiment, the computer system 100 may further include a network interface 160 for coupling to a network 165. The network 165 may be an IP-based network for communication between the computer system 100 and any external server, client and the like via a broadband connection. The network 165 transmits and receives data between the computer system 100 and external systems. In an exemplary embodiment, the network 165 may be a managed IP network administered by a service provider. The network 165 may be implemented in a wireless fashion, e.g., using wireless protocols and technologies, such as WiFi, WiMax, etc. The network 165 may also be a packet-switched network such as a local area network, wide area network, metropolitan area network, the Internet, or other similar type of network environment. The network 165 may be a fixed wireless network, a wireless local area network (LAN), a wireless wide area network (WAN) a personal area network (PAN), a virtual private network (VPN), intranet or other suitable network system and may include equipment for receiving and transmitting signals.

Tagging systems and methods according to this disclosure may be embodied, in whole or in part, in computer program products or in computer systems 100, such as that illustrated in FIG. 1.

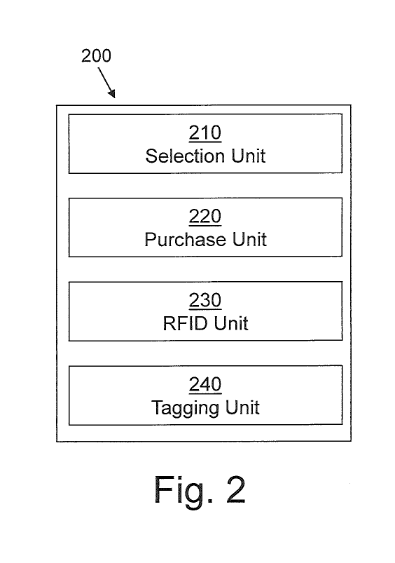

FIG. 2 is a block diagram of a tagging system 200, according to an exemplary embodiment of this disclosure. The tagging system 200 may enable convenient identification and tagging of objects in digital media, such as photographs. The tagging system 200 may be integrated into, or otherwise in communication with, a system or website capable of displaying digital media, such as a social networking website. Although this disclosure refers to the tagging system 200 in the context of a social networking website, it will be understood that carious embodiments of this disclosure are not limited to that context.

As shown, the tagging system 200 may include a selection unit 210, a purchase unit 220, an RFID unit 230, and a tagging unit 240. It will be understood that, although the RFID unit 230, the purchase unit 220, and the tagging unit 240 appear separate in FIG. 2, this need not be the case. Rather, depending on the implementation, these components may share hardware, software, or both. When a photo is uploaded to the social networking site, or otherwise becomes accessible to the tagging system 200, the tagging unit 240 may suggest various tags for one or more objects in the photo, based on information from the purchase unit 220 and the RFID unit 230. These tag suggestions may be based on one or more of the following: purchase history of users associated with the photo, RFID labels associated with objects in the photo, the photo's metadata, and image analysis.

When a photo is uploaded, the selection unit 210 may determine which objects in the photo are taggable objects, i.e., objects that the tagging system 200 will attempt to tag. Such determination may be made through various means. In some embodiments, the selection unit 210 may leverage conventional means of recognizing taggable objects, such as Google Goggles™. Alternatively, or additionally, a primary user who uploaded or owns the photo may select portions of the photo, thus indicating that each of such portions represent taggable objects. For another example, the tagging system 200 may use image analysis to select objects that are taggable. For each taggable object, the tagging unit 240 may attempt to tag such object.

Taggable objects may be, for example, clothing, accessories, vehicles, food, beverages, or other objects. In some embodiments, the selection unit 210 may determine a class or category to which a taggable object belongs (e.g., food, drink, shirt, handbag, shoes, coat) or other characteristics about the object (e.g., color, brand) using image analysis techniques. Such details may enable the tagging unit 240 to more accurately or more efficiently suggest tags.

The tagging unit 240 may generate a set of potentially matching objects, which may include objects which may match the taggable object. Details provided by the selection unit 240 may be useful toward generating this set. For example, if the selection unit determines that the taggable object is a hat, then the set of potentially matching objects may all be hats, excluding other non-hat objects that might be known to the tagging system 200. Information received from the purchase unit 220 and the RFID unit 230 may also be used in generating the potentially matching objects.

The purchase unit 220 may maintain, or have access to, data related to purchases of various users. Acquiring purchasing history may occur in various manners. For example, and not by way of limitation, when a user registers with the tagging system 200, that user may grant some degree of access to his financial accounts, store loyalty accounts, credit cards, or other accounts associated with purchasing. The purchase unit 220 may analyze data related to purchases made with the accessible accounts. For example, and not by way of limitation, by examining a digital purchase receipt, the purchase unit 220 may determine that a red shirt in a specific size was purchased at a specific store. The purchase unit 220 may also determine the date and geographic location of the purchase and, if applicable, a website address for the store's online presence or a website address where the product can be purchased. This data related to the purchase may be stored in a purchase database and associated with the user who made the purchase. It will be understood that the term “database,” as used herein, need not be limited to a relational database but may instead encompass various structures for maintaining organized data.

The purchase unit 220 may maintain and update a user's purchase history in various ways. For example, in some embodiments, the purchase unit 220 may monitor the accessible accounts on a periodic basis and may analyze and store new data from those accounts when new purchases are detected. In some embodiments, the purchase unit 220 may receive push notifications from servers associated with the accessible accounts, so that purchase data may be more efficiently updated without the accounts being periodically polled by the purchase unit 220. Other implementations may also be possible.

After a photo is uploaded one or more users may be tagged in the photo. Purchase data related to users associated with the photo may be used in generating the potentially matching objects. These associated users may include the primary user, one or more of the tagged users in the photo, or a combination thereof. When generating the potentially matching objects, the tagging unit 240 may include objects in the associated users' purchase histories, particularly the purchase history of a tagged user wearing or carrying the taggable object, that have the characteristics that the taggable object is deemed to have. For example, suppose the selection unit 210 identifies a taggable object as a shirt, and the taggable object is being worn by a specific tagged user in the photo. In that case, the tagging unit 240 may include, in the set of potentially matching objects, shirts purchased by the tagged user. If objects worn or carried by the tagged user have been tagged in the past, even if not in the purchase history of the tagged user, those previously worn or carried items may also be included in the potentially matching objects.

In some embodiments, the tagging unit 240 may examine more than a single user's purchase history when filtering the set of known objects. For example, and not by way of limitation, the tagging unit 240 may also consider the purchase history of the photo's owner, of other users tagged in the photo, or of the tagged user's friends. Considering these other users' purchase histories may improve tag suggestions where the tagged user has borrowed the taggable object, or where the selection unit 210 inaccurately attributed a tagged object as being carried by a first tagged user as opposed to a second tagged user in the same photo.

The photo's timestamp may be used to limit which objects are included in the set of potentially matching objects. In some embodiments, a photo's timestamp may be set as the time the photo was uploaded to the social networking site. For example, and not by way of limitation, if the timestamp indicates summer time, then the tagging unit 240 may exclude heavy coats that are found in the associated users' purchase histories. Objects purchased after the timestamp of the photo may also be excluded. Additionally, in some embodiments, consumable objects, such as food and drink, may be excluded after a reasonable time period during which one would expect them to be consumed. For example, a coffee purchased a month prior to the timestamp may be excluded from the reduced set even if the tagged user appears to be holding a drink.

In some embodiments, the RFID unit 230 of the tagging system 200 may contribute data utilized by the tagging unit 240 in generating the set of potentially reduced objects. The RFID unit 230 may seek to identify information about taggable objects based on RFID labels. Photos uploaded to the tagging system 200 may include metadata that includes RFID labels for objects in the photo. Such metadata may be generated when the photo is captured, for example, by a camera having an attached or integrated RFID reader that captures RFID data from RFID tags of objects. Many consumer goods on the market today have passive RFID tags, of which the tagging system 200 can take advantage when a photo is captured by such a camera. A low-range RFID reader may suffice and may produce better results than a high-range RFID reader, which would be more likely to read tags outside of the camera's field of view. Accordingly, after the photo is uploaded, the RFID unit 230 may access the photo metadata and extract the RFID label of the taggable object.

It will be understood that, although this disclosure refers to the use of RFID tags in identifying taggable objects, the various embodiments of the tagging system 200 are not limited to this technology. Rather, various other wireless object identification technologies may be used in place of, or in addition to, RFID.

Commonly, RFIDs are used by consumer goods sellers to identify their products. Sellers are often assigned blocks of RFIDs. The RFID unit 230 may access such a database and may use it to assist in identifying objects associated with RFID labels of a photo. By comparing the RFID labels with data in this RFID database, the RFID unit 230 may identify an object in the photo as a specific object, if such object is indicated by the database, or as a class of objects or as belonging to a particular store or brand. When available, this information may be used to limit which objects are included in the set of potentially matching objects, or may be used to add potentially matching objects to the set.

Some embodiments of the tagging unit 240 may use both the purchase unit 220 and the RFID unit 230, as opposed to simply one or the other, to enhance the accuracy and precision of the set of potentially matching objects. For example, and not by way of limitation, if the RFID unit 230 determines that an identified RFID tag is associated with a specific store, the purchase unit 220 may then search only the objects corresponding to that store when examining the purchase histories.

Further, in some embodiments, image recognition may be used to assist in identifying a taggable object. For example, the tagging unit 240 may have access to a set of source images in one or more databases, which may be databases of a store, manufacturer, retailer, or other entity associated with products. Each source image may depict an object. In some cases, multiple source images may be accessible for a single object, corresponding to various views (e.g., side, top, perspective) of the object. For each identified RFID label in a photo, the tagging unit 240 may compare the photo to the various source images of the entity associated with that RFID label, thus assisting in the identification. Analogously, similar image recognition may be used to identify the taggable object based on one or more purchase histories, using the source images associated with the stores for those purchase histories.

It will be understood that, when both purchase histories and RFID tags are used, the order in which these and other techniques are applied to select the potentially matching objects is implementation dependent. In other words, use of purchase histories may occur before or after, or both before and after, use of RFID tags. Furthermore, additional techniques may also be used to assist in generating the set of potentially matching objects. For example, and not by way of limitation, such an additional technique may include determining a pattern of object tags made by the primary user or object tags associated with tagged users, and using such pattern to generate the potentially matching objects.

Using one or more of the above techniques, the tagging system 200 may, for the taggable object, generate a set of potentially matching objects. The tagging system 200 may present one, some, or all of the potentially matching objects as suggested matches for the taggable object. Suggestions may be presented in various ways. In some embodiments, when the photo is uploaded or when it is being displayed after upload, the tagging system 200 may automatically prompt the user to tag objects, and may include one or more suggested tags from the potentially matching objects. In some instances, after the user manually indicates a desire to tag objects the photo, the tagging system 200 may then present the suggestions. Suggestions may, in some embodiments, be presented when a user clicks on an object in the photo. In that case, the suggested tags may be limited to those corresponding to the clicked object, assuming the clicked object is deemed to be a taggable object.

After suggestions are presented, the user may select one of the suggested objects, thus indicating that the selected object identifies the taggable objects. Alternatively, the user may reject all the suggestions and either identify the taggable object as being other than the suggestions or decline to tag the taggable object. If a matching object is identified, by selection, by manual entry, or by other means, the tagging system 200 may associate with the taggable object a tag representing the matching object. The tag may include various information about the object, such as, for example, the type of object, brand, brand website, or purchase website. In an exemplary embodiment, the tag includes enough information to identify the object to a user viewing the photo.

In an example use case of the tagging system 200, a first user purchases branded sunglasses from a local store that is part of a franchise. The first user pays for his purchase using the store's credit card. The store transmits this data to a third party that collects and tracks purchase data. As per a preregistration of this card with a social networking account of the first user, the social networking account receives the purchase data from the third party. This purchase data may include, for example, the type of item (i.e., sunglasses), the brand, a local store identifier and location, and an associated RFID label.

A second user captures and uploads a photo of the user wearing the purchased sunglasses, and then tags the first user in the photo. Because the camera had an integrated RFID reader, the photo's metadata includes an RFID label of the sunglasses. When the photo is uploaded, the tagging system 200 gains access to the RFID label of the sunglasses, the photo's timestamp, and various other RFID labels associated with other objects in the photo. The tagging system 200 compares the RFID label to the purchase histories of one or more of the second user (who uploaded the photo), the first user (who is tagged in the photo), and other users in the households of the first and second users. These purchase histories may be used to discard RFID labels captured in the photo metadata that do not belong to the associated users. The tagging system 200 may then map the remaining RFID labels of the photo to one or more stores, including the store at which the sunglasses were purchased. The tagging system 200 may then determine that those sunglasses were the only ones, or one of the few sunglasses, purchased at those stores.

The tagging system 200 then prompts the second user to tag the sunglasses with an object identification that includes various information about the sunglasses, such as brand, store name, or store location. If the first user consents, the tagging system 200 tags the photo with this information. Some embodiments of the tagging system 200 may further require that the first user, i.e., the user wearing or carrying the sunglasses in the photo, also consent to the tagging. In some embodiments, the tagging system may allow representatives of the store to reject the tag, if for some reason those representatives do not appreciate the photo or do not want their product identified in it.

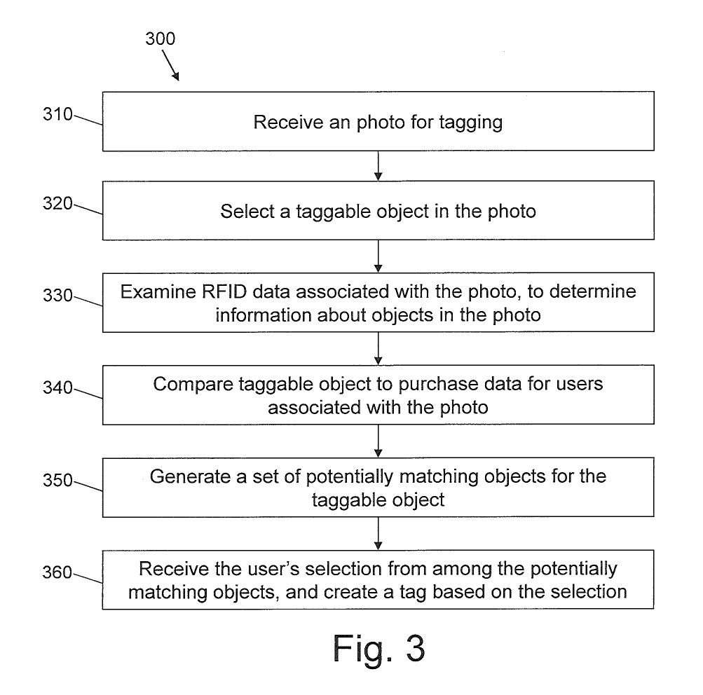

FIG. 3 is a flow diagram of a method 300 for tagging an object in a photo, according to some embodiments of this disclosure. As shown, at block 310, the tagging system 200 may receive access to a recently uploaded photo. At block 320, the tagging system 200 may select a taggable object in the photo. At block 330, the RFID unit 230 may analyze RFID data associated with the photo. For example, the RFID unit 230 may compare an RFID label in the photo's metadata to an RFID database, thus identifying a store at which the object was purchased. At block 340, the purchase unit 220 may search the purchase data of users associated with the photo, specifically focusing on purchases made at the identified store. At block 350, the tagging system 200 may generate a set of potentially matching objects for the taggable object, and may suggests one or more of these to be used as a tag. At block 360, the tagging system 200 may receive a selection of one of the potentially matching objects and may create a tag according to that selection.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-7. (canceled)

8. A system comprising:
a selection unit configured to select a taggable object appearing in a photo;
a purchase unit configured to collect first purchase data related to past purchases of a first user associated with the photo, and to compare the first purchase data to the taggable object to determine whether one or more purchased items potentially match the taggable object; and
a tagging unit configured to generate a set of potential matches based, at least in part, on comparing the first purchase data to the taggable object, and to tag the taggable object in the photo with an identifier representing at least one of the potential matches.

9. The system of claim 8, the tagging unit being further configured to tag the taggable object in the photo by indicating at least one of where the taggable object is purchasable and the brand of the taggable object.

10. The system of claim 8, further comprising:
an RFID unit configured to:
identify an RFID label associated with the photo; and
determine information about the taggable object based at least in part on the RFID label;
wherein the identification unit is further configured to generate the set of potential matches by comparing the first purchase data to the information about the taggable object determined from the RFID label.

11. The system of claim 8, further comprising an RFID unit configured to:
identify an RFID label associated with the photo; and
determine a store at which the taggable object was purchased, based at least in part on the RFID label.

12. The system of claim 8, the selection unit being further configured to conduct image analysis to determine one or more characteristics of the taggable object, wherein the tagging unit is further configured to compare the first purchase data to the taggable object by comparing the one or more characteristics of the taggable object to the first purchase data.

13. The system of claim 8, the tagging unit being further configured to suggest one or more of the potential matches to a primary user as a possible tag for the taggable object.

14. The system of claim 8, the purchase unit being further configured to:
collect second purchase data related to past purchases of a second user associated with the photo; and
compare the second purchase data to the taggable object to determine whether one or more purchased items potentially match the taggable object;
wherein the first user owns the photo and the second user is tagged in the photo.

15-20. (canceled)
